(19) United States
(12) Patent Application Publication
(10) Pub. No.: US 2005/0228917 A1
(43) Pub. Date: Oct. 13, 2005

(54) Novel structure and method for interrupt detection and processing

(76) Inventors: Peter C. Brink, Tempe, AZ (US); Shrikant M. Shah, Chandler, AZ (US)

Correspondence Address: SCHWEGMAN, LUNDBERG, WOESSNER & KLUTH, P.A., P.O. BOX 2938, MINNEAPOLIS, MN, 55402-0938, US

(21) Appl. No.: 10/813,602

(22) Filed: Mar. 30, 2004

(51) Int. Cl. G06F 12/00

(52) U.S. Cl. 710/200

(57) ABSTRACT

An electronic system includes a processor and an interrupt structure. The interrupt structure handles interrupt information such as interrupt requests, interrupt function types, and interrupt data without involving the processor. The processor performs interrupt functions according to the interrupt information at times independent from the times the interrupt requests are received by the interrupt structure.

### FIELD

Embodiments of the present invention relate generally to electronic systems and, more particularly, to computers with interrupt controllers.

### BACKGROUND

An electronic system such as a computer usually has a central processing unit or a processor and many other input output (I/O) devices such as keyboard, mouse, display monitor, printer, scanner, modem, and network card. The I/O devices often need service from the processor to transmit, receive, or modify data based on the functionality or type of the I/O device.

Typically, the I/O devices send interrupt requests to the processor when they need service. Each time the processor receives an interrupt request, the processor suspends its current function to perform an interrupt function, commonly called an interrupt service routine or ISR, according to the type of the interrupt request. The processor resumes the suspended function after it finishes the interrupt function.

In the typical computer, one or more I/O devices may send numerous interrupt requests to the processor while the processor performs a current function. Consequently, the processor may repeatedly suspend and resume the current function to handle the interrupt requests. Thus, handling the interrupt requests in a typical computer may become complicated and time consuming.

### BRIEF DESCRIPTION OF DRAWINGS

FIG. 1 shows a system including an interrupt structure.

FIG. 2 shows a circuit diagram of an intelligent interrupt controller.

FIG. 3 is a flowchart of a method of processing an interrupt request.

### DESCRIPTION OF EMBODIMENTS

The following description and the drawings illustrate specific embodiments of the invention sufficiently to enable those skilled in the art to practice the invention. Other embodiments may incorporate structural, logical, electrical, process, and other changes. In the drawings, like numerals describe substantially similar components throughout the several views. Examples merely typify possible variations. Portions and features of some embodiments may be included in or substituted for those of others. The scope of the invention encompasses the full ambit of the claims and all available equivalents.

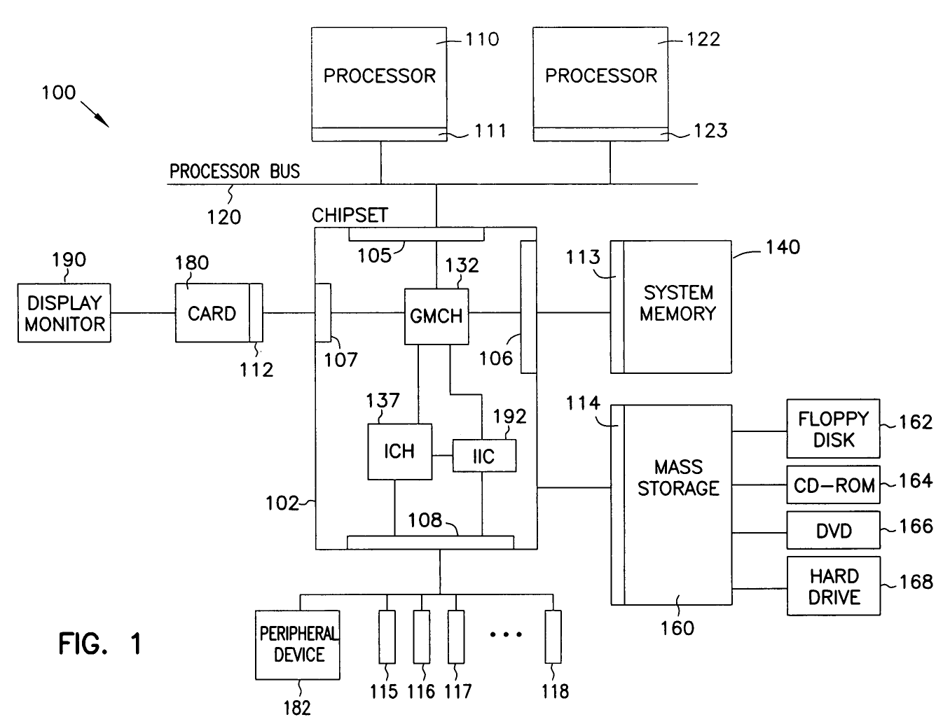

FIG. 1 shows a system including an interrupt structure. System 100 includes a chipset 102. A number of connectors 111-118 connect chipset 102 to a number of devices such as a processor 110, a system memory (memory device) 140, a mass storage device 160, a card 180, a peripheral device 182, and a display monitor 190. System 100 may include other devices of a computer, which are not shown for clarity. All of the elements of system 100 may be located on a circuit board, for example a motherboard.

Connectors 111-118 include ports, slots, sockets, or other interfaces that allow different devices to connect together. Each of the connectors 111-118 includes a number of connection points such as solder ball contacts and pins to receive a device or a card. Connectors 111-118 are configured according to one or more interface standards. Peripheral device 182 may be a keyboard, a pointing device or mouse, a printer, a scanner, a modem, or a network card.

Chipset 102 may support one or more interfaces. Each interface defines a separate hierarchy domain. Each hierarchy domain may include a single endpoint or a sub-hierarchy containing one or more switch components and endpoints. For example, chipset 102 may include a processor interface 105 to communicate with processor 110, a memory interface 106 to communicate with system device 140, a graphic interface 107 to communicate with card 180, and an input output interface 108 to communicate with mass storage 160 and with devices connected to connectors 115-118. In some embodiments, interfaces 107 and 108 are together referred to as a peripheral interface.

Chipset 102 may include an integrated graphics and memory controller hub (GMCH) 132, an I/O hub controller (ICH) 137, and an intelligent interrupt controller (IIC) 192. GMCH 132 provides control and configuration of memory, graphics, and input/output (I/O) devices such as system memory 140 and the ICH 137. ICH 137 has a number of functionalities to support I/O functions. ICH 137 may include a number of interface and I/O functions such as direct memory access (DMA) controller, power management logic, timer, system management bus (SMBus), universal serial bus (USB) interface, mass storage interface (IDE and floppy controllers), low pin count (LPC) interface, and others.

FIG. 1 shows GMCH 132, ICH 137, intelligent interrupt controller 192 as three separate blocks representing three separated integrated circuit chips. In some embodiments, GMCH 132, ICH 137, intelligent interrupt controller 192 may reside in one or two blocks representing one or two integrated circuit chips.

Processor 110 represents a central processing unit of any type of architecture, such as embedded processors, mobile processors, micro-controllers, digital signal processors, superscalar computers, vector processors, single instruction multiple data (SIMD) computers, complex instruction set computers (CISC), reduced instruction set computers (RISC), very long instruction word (VLIW), or hybrid architecture.

A processor bus 120 provides interface signals to allow processor 110 to communicate with other processors such as processor 122 via processor interface 123, or with devices such as chipset 102. Processor bus 120 may support a uni-processor or multiprocessor configuration. Processor bus 120 may be parallel, sequential, pipelined, asynchronous, synchronous, or any combination thereof. In some embodiment, beside processor 110, system 100 includes one or other more processors connected to processor bus 120.

System memory 140 stores system code and data. System memory 140 may include dynamic random access memory (DRAM) or static random access memory (SRAM). System memory 140 may include program code or code segments implementing the embodiments of the invention. System memory 140 may also include other programs or data such as an operating system.

Mass storage device 160 stores information such as code, programs, files, data, applications, and operating systems. Mass storage device 160 may include machine-readable media such as a floppy disk 162, a digital video/versatile disc (DVD) 164, a compact disk Read Only Memory (CD-ROM) 166, a hard disk 168, and any other magnetic or optical storage device.

Card 180 may be a digital display card such as a graphic card. Card 180 may contain devices that provide display signals to drive display monitor 190. Card 180 is plugged into or connected to connector 112 to interact with GMCH 132 of chipset 102. In some embodiments, card 180 is compatible with a suitable SDVO display format and contains an SDVO device that generates digital display signals. In some embodiment, card 180 may be an Accelerated Graphics Port card (graphics card) or an Accelerated Graphics Port Digital Display second generation card (ADD2 card).

Monitor 190 may be either an analog monitor or a digital monitor. For example, monitor 190 may be a flat panel display such as Liquid Crystal Display (LCD), electroluminescent display (ELD), gas-plasma display, a cathode-ray tube (CRT) display, or a television (TV) set. In some embodiments, card 180 is omitted and monitor 190 connects directly to chipset 102.

In system 100, the combination of chipset 102 and system memory 140 forms an interrupt structure to handle interrupt information from one or more devices such as peripheral device 182 or other devices connected to connectors 115-118. The interrupt structure of system 100 is configured to handle interrupt information independently from processor 110. Examples of the interrupt information include the identification of the device requesting the interrupt, the function and data associated with the interrupt.

Intelligent interrupt controller 192 includes elements to acquire interrupt information. The interrupt information is passed to system memory 140 without passing the interrupt information to processor 110. System memory 140 stores the interrupt information for use by processor 110 at a time chosen by processor 110.

In some embodiments, since GMCH provides control and configuration to system memory 140, intelligent interrupt controller 192 passes the interrupt information to GMCH 132. Subsequently, GMCH 132 passes the interrupt information to system memory 140 without passing the interrupt information to processor 110.

Processor 110 polls system memory 140 to check for any interrupt information stored in system memory 140. If interrupt information is present, processor 100 performs an interrupt function based on the interrupt information. Thus, in system 100, processor 100 does not directly handle the interrupt information. Processor 100 performs an interrupt function based on the interrupt information.

In some embodiments, processor 110 is configured to poll system memory at a time independent from the time an interrupt request is received at chipset 102. For example, processor 110 may be configured to poll system memory 140 after it finishes a current function. As another example, processor 110 may be configured to poll system memory 140 when a current function is not a time sensitive function such as a backup function.

In system 100, since processor 110 does not directly handle the interrupt information, handling interrupt information in system 100 may be less complicated than in a system with a processor directly handling the interrupt information. Further, in system 100, since processor 110 does not handle the interrupt information directly, processor 110 may finish a function within a time interval smaller than a time interval to perform the same function in a system with a processor directly handling the interrupt information.

In some embodiments, chipset 102 may include an internal chipset memory device similar to system memory 140 and chipset 102 stores the interrupt information in the internal chipset memory device instead of in system memory 140. Thus, embodiments exist where processor 110 obtains the interrupt information by polling a memory device residing inside chipset 102 instead of polling memory device 104.

In embodiments having multiple processors connected to chipset 102, a first processor such as processor 110 may perform a particular function while a second processor may poll system memory 140 to check for the interrupt information.

In FIG. 1, system 100 represents computers such as a desktops, laptops, hand-held devices, servers, Web appliances, and routers. In some embodiments, system 100 may be included in wireless communication devices such as cellular phones, cordless phones, pagers, and personal digital assistants. System 100 may also be included in computer-related peripherals such as printers, scanners, and monitors, or entertainment devices such as televisions, radios, stereos, tape and compact disc players, video cassette recorders, camcorders, digital cameras, MP3 (Motion Picture Experts Group, Audio Layer 3) players, and video games.

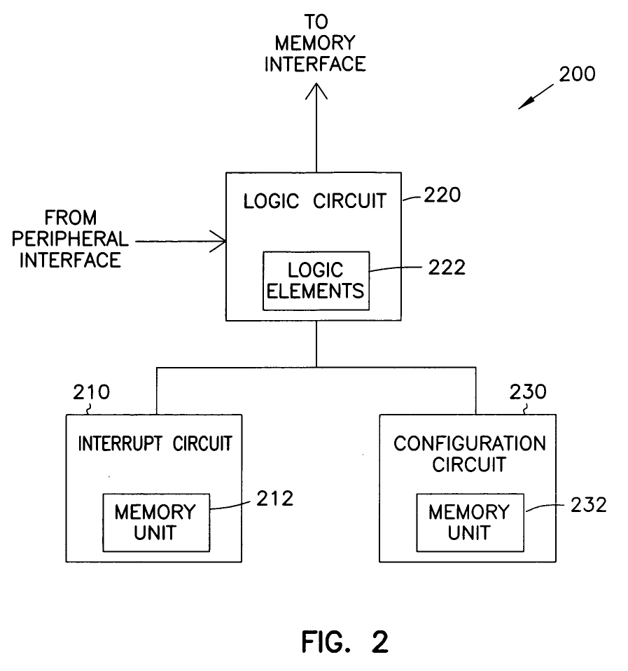

FIG. 2 shows a circuit diagram of an intelligent interrupt controller. Intelligent interrupt controller 200 may be used in chipset 102 of FIG. 1. Intelligent interrupt controller 200 includes an interrupt circuit 210, a logic circuit 220, and a configuration circuit 230.

Interrupt circuit 210 is configured to store interrupt information. The interrupt information may be originated (sent) from one or more devices such as the devices connected to chipset 102 shown in FIG. 1 or devices connected to connectors 115-118 of FIG. 1. Examples of the interrupt information include the identification of the device originating the interrupt request, priority of the interrupt request, interrupt function types, and interrupt data. Interrupt circuit 210 may include a local memory unit 212 to store the interrupt information. Memory unit 212 may be a cache memory having random access memory (RAM) cells such as static RAM cells.

Logic circuit 220 is configured to acquire the interrupt information. Logic circuit 220 includes logic elements 222 to determine the identification of the device originating the interrupt signal and to acquire from the device originating information such as the interrupt function and data associated with the interrupt request. As discussed above, the interrupt information is stored locally in memory unit 212 of interrupt circuit 210. After the interrupt information is acquired, logic circuit 220 passes the interrupt information to a memory device such as system memory 140 of FIG. 1. The memory device stores the interrupt information at a memory location according to a configuration address.

Configuration circuit 230 is configured to store configuration data. Configuration circuit 230 includes a memory unit 232 to store the configuration data. Memory unit 232 may be a register or may be a read only memory (ROM) device such as an EPROM or EEPROM device. The configuration data stored in memory unit 232 includes configuration addresses. Each configuration address corresponds to a different memory block in a memory device such as system device 140 of FIG. 1. After the interrupt information is passed to the memory device, the interrupt information is stored in the memory device at a location according to the configuration address indicated by memory unit 232. The configuration data stored in memory unit 232 may also include a number of devices that intelligent interrupt controller 200 is configured to handle.

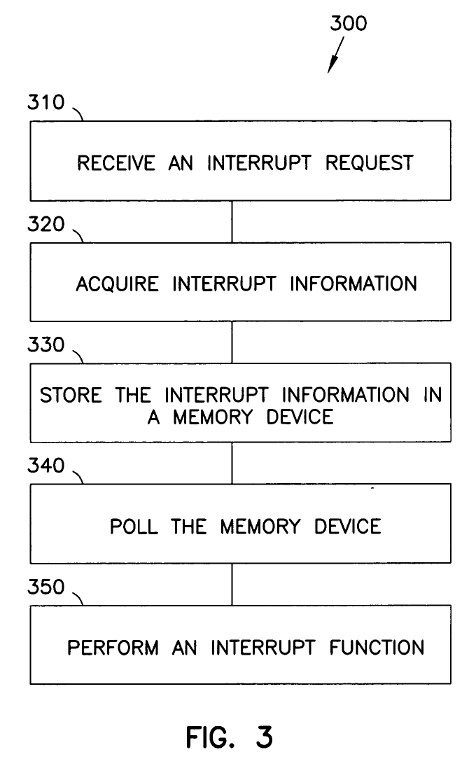

FIG. 3 is a flowchart of a method of processing an interrupt request. Method 300 may be used in a system such as system 100 of FIG. 1. Method 300 receives interrupt information at a chipset. The interrupt information is stored in a memory device. The chipset and the memory device may be located in the same integrated circuit chip or in separated integrated circuit chips. The chipset may be an integrated circuit including only an interrupt controller such as intelligent interrupt controller 192 (FIG. 1) or intelligent interrupt controller 200 (FIG. 2). The chipset may also be an integrated circuit including any combination of a graphics and memory controller hub, an input and output controller hub, and an intelligent interrupt controller such as those shown in FIG. 1 and FIG. 2.

In method 300, the processor is not notified of the presence of the interrupt information at the time the interrupt information is received at the chipset. The processor polls the memory device to check for the interrupt information and performs an interrupt function based on the interrupt information.

Box 310 receives an interrupt request at the chipset. The interrupt request may be one or more signals originated by a device connected to the chipset. For example, the interrupt signal may be originated by peripheral device 182 of FIG. 1. As another example, the interrupt signal may be originated by a device connected one of the connectors 115-118.

Box 320 acquires interrupt information. After receiving the interrupt request, the chipset communicates with the device originating the interrupt request to acquire interrupt information associated with the interrupt request. Examples of the interrupt information include the identification of the device, the priority of the interrupt request, the function associated with the interrupt request, and any data associated with the interrupt request. The interrupt information is temporarily stored at a local memory unit such as a register within the chipset.

Box 330 stores the request information in the memory device. After acquiring the interrupt information, the chipset passes the interrupt information to the memory device. The memory device stores (writes) the interrupt information to a specific memory location based on a configuration address. The chipset provides the configuration address. The chipset includes a configuration memory unit to store the configuration address.

In some embodiments, a number of devices connect to the chipset. The chipset stores a number of configuration addresses in the configuration memory unit. Each of the configuration addresses corresponds to a memory block in the memory device. The memory block stores interrupt information of a corresponding external device.

Box 340 polls the memory device. A processor connected to the chipset polls the memory device to check for any interrupt request stored in the memory device. In method 300, the processor is not notified when an interrupt request is received at the chipset. Thus, the processor is not interrupted when an interrupt request occurs. In method 300, the chipset handles the interrupt information. The processor performs an interrupt function based on the interrupt information stored in the memory device. The processor may be configured to poll the memory device at a time independent from the time an interrupt request is received at the chipset. For example, the processor may be configured to poll the memory device after it finishes a current function. As another example, the processor may be configured to poll the memory device when a current function is not a time sensitive function such as a backup function.

In method 300, since the processor does not directly handle the interrupt information, handling interrupt information in method 300 may be less complicated than in a method with a processor directly handling the interrupt information. Further, in method 300, since the processor does not directly handle the interrupt information, the processor may finish a function within a time interval smaller than a time interval to perform the same function in a system with a processor directly handling the interrupt information.

In some embodiments, two or more processors may be connected to the chipset. For example, two or more processors may be connected to the chipset via the same process bus. In these embodiments, a first processor may perform a particular function while a second processor may perform the polling of the memory device to check for the interrupt information.

Box 350 performs a function based on the interrupt information. After the processor polls the memory device, the processor performs a function based on the interrupt information stored in the memory device.

Method 300 may be performed in any order. For example, any combination of the functions in boxes 310, 320, 330, 340 and 350 may be performed in a serial fashion or in a parallel fashion.

1. An integrated circuit comprising:
a peripheral interface to receive an interrupt request;
a memory interface to communicate with a memory device;
a processor interface to communicate with a processor; and
a logic circuit connected to the peripheral interface to acquire the interrupt information associated with the interrupt request, wherein the logic circuit is also connected to the processor interface and the memory interface to pass the interrupt information to the memory device without passing the interrupt information to the processor interface.

2. The integrated circuit of claim 1 further includes a memory unit to store the interrupt information before the interrupt information is passed to the memory interface.

3. The integrated circuit of claim 1 further comprising a configuration circuit to store configuration address indicating a location in the memory device to store the interrupt information.

4. The integrated circuit of claim 3, wherein the configuration circuit includes a read only memory device to store the configuration address.

5. The integrated circuit of claim 1 further comprising a graphics interface to communicate with a graphics card.

6. A system comprising:
a processor;
a memory device; and
a chipset connected to the processor and the memory device, wherein the chipset is configured to receive interrupt information and to pass the interrupt information to the memory device without notifying the processor the presence of the interrupt information.

7. The system of claim 6, wherein the chipset includes a graphic and memory control hub to process graphic and memory information and to provide access between the processor and the memory device.

8. The system of claim 7, wherein the chipset further includes an input output control hub connected to the graphic and memory control hub to process input output information between the chipset and external devices.

9. The system of claim 8, wherein the chipset further includes an interrupt controller to receive the interrupt information.

10. The system of claim 6, wherein the processor is configured to poll the memory device to check for the interrupt information at a time independent from a time the interrupt information is received by the chipset.

11. The system of claim 6 further comprising a second processor connected to the chipset.

12. The system of claim 11, wherein the second processor is configured to poll the memory device to check for the interrupt information at a time independent from a time the interrupt information is received by the chipset.

13. A method comprising:
receiving an interrupt request at an interrupt controller;
acquiring, at the interrupt controller, interrupt information corresponding to the interrupt request; and
passing the interrupt information from the interrupt controller to a memory device without passing the interrupt information to a processor.

14. The method of claim 13 further comprising:
polling the memory device to check for the interrupt information.

15. The method of claim 14, wherein polling is performed by the processor at a time independent from a time the interrupt request is received by the interrupt controller.

16. The method of claim 14 further comprising:
performing an interrupt function based on the interrupt information.

17. The method of claim 14, wherein polling is performed by a second processor a time independent from a time the interrupt request is received by the interrupt controller.

18. The method of claim 13, wherein the memory device and the interrupt controller are located in separate chips.

19. The method of claim 13, wherein passing the interrupt information from the interrupt controller to the memory device includes writing the interrupt information to the memory device at a memory location according to configuration information.

20. The method of claim 19, wherein the configuration information is stored in the interrupt controller.

21. A method comprising:
receiving an interrupt request at a chipset, the chipset connecting to a processor;
acquiring, at the chipset, interrupt information corresponding to the interrupt request;
storing the interrupt information at a memory location without notifying the processor the interrupt request; and
polling the memory device to check for the interrupt information, wherein polling is performed at a time independent from a time the interrupt request is received at the chipset.

22. The method of claim 21, wherein polling is performed by the processor.

23. The method of claim 21, wherein polling is performed by a second processor connected to the chipset.

24. The method of claim 21 further comprising:
performing an interrupt function based on the interrupt information stored in the memory location.

25. The method of claim 21, wherein storing the interrupt information at the memory location includes storing the interrupt information in a memory device separate from the processor and the chipset.

26. The method of claim 25, wherein storing the interrupt information at the memory location includes storing the interrupt information at the memory location according to a configuration information.

27. The method of claim 26, wherein the configuration information is stored in the chipset.
